(19) United States
(12) Patent Application Publication
(10) Pub. No.: US 2019/0113381 A1
(43) Pub. Date: Apr. 18, 2019

(54) Lift Truck Scales and Methods of Using the Same

(71) Applicant: Chicago Measurement, LLC, De Soto, IL (US)

(72) Inventor: Robert T. Pangrazio, Van Buren, AR (US)

(21) Appl. No.: 16/162,143

(22) Filed: Oct. 16, 2018

Related U.S. Application Data
(60) Provisional application No. 62/572,622, filed on Oct. 16, 2017.

(51) Int. Cl. G01G 19/08; B66F 9/075; B66F 9/07; B66F 9/08; B66F 9/12

(52) U.S. Cl. CPC G01G 19/083; B66F 9/07504; B66F 9/12; B66F 9/08; B66F 9/07

(57) ABSTRACT

Forklift truck scales comprise a scale assembly having a back plate and a front plate, the back plate connected to a mast on a lift truck and the front plate having a pair of forks for holding pallets or other items thereon. The front plate is held to the back plate via a plurality of laterally spaced and adjustable chains or cables near a top thereof and allowed to move vertically relative to each other via a roller near a bottom thereof. One or more load sensing elements or load cells are utilized to determine the weight of the load. The present invention minimizes inaccurate load readings, allows for quick and easy “heel to toe” adjustments of the scale, and further allows for in-motion weighing.

The present invention claims priority to U.S. Provisional Patent Application No. 62/572,622, titled “Lift Truck Scales and Methods of Using the Same,” filed Oct. 16, 2017, which is incorporated herein by reference in its entirety.

### TECHNICAL FIELD

The present invention relates to lift truck scales. Specifically, the lift truck scales of the present invention comprise a scale assembly comprising a back plate and a front plate, the back plate connected to a mast on a lift truck and the front plate having a pair of forks for holding pallets or other items thereon. The front plate is held to the back plate via a plurality of laterally spaced and adjustable chains or cables near a top thereof and allowed to move vertically relative to each other via a roller near a bottom thereof. One or more load sensing elements or load cells can be utilized to determine the weight of the load. The present invention minimizes inaccurate load readings, allows for quick and easy “heel to toe” adjustments of the scale, and further allows for in-motion weighing.

### BACKGROUND

The ability to utilize forklifts to pick up and move objects, such as pallets, crates, boxes, and the like, is well-known. A forklift generally includes a truck, having a cab and controls for a driver, a mast providing vertical movement of a carriage, and a set of horizontal load-bearing forks extending from the carriage. Typically, the vertical movement of the carriage allows the forks to be placed beneath a load, which may be lifted and moved using the forklift.

Many forklifts also include scales between the carriage and the forks that allow for measuring of the weight of the load of the objects being moved. Generally, a scale typically includes a pair of vertically-disposed, spaced-apart plates that are connected together via a plurality of flexures, or springs, allowing for measurement of the load via a load sensing element or load cell. The load cell is preferably an electronic strain gauge sensor, but may be a hydraulic sensor, or other like load sensor apparent to one of ordinary skill in the art. A load pulls down on a front plate of the pair of vertically-disposed plates, thereby flexing the flexures and imparting the load onto the load sensing element that translates the pressure on the load sensing element into a display of the weight of the load.

The flexures of prior art forklift scales typically do not provide completely accurate readings. Specifically, because the flexures act as springs, they can cause imperfect loading on the load cell because some of the weight of the load is carried on the flexures themselves, causing inaccurate load sensing. For example, when the mast is tilted forward or backward, the flexures can actually cause the weight of the load to go up before going down, since the flexures act as springs. This can lead to inaccurate readings.

Over time, because the flexures bear some of the weight of the load, they tend to deform, bend or even break, requiring replacement of the same. Replacement can be costly and require forklifts to be taken out of commission until replaced. In addition, bent or deformed flexures can also provide further inaccuracies when reading the weight of a load.

Because the flexures act like springs, movement of the forklift as the load is weighed can interfere with the load sensor from obtaining a complete and accurate measurement of the weight of the load. Therefore, when taking readings of the load weight using the scales, the forklift typically must be completely still. Thus, so-called “in-motion” weighing cannot be done.

In use, lift truck scales typically require adjustments to ensure that the load sensor is receiving the full weight of the load. For example, oftentimes the flexures must be adjusted to ensure that the front plate and the back plate are positioned properly. Oftentimes, shims are used and placed under the flexures to ensure the proper positioning of the front plate relative to the back plate. This process is very time-consuming, often taking hours to accomplish.

A need, therefore, exists for improved lift truck scales. Specifically, a need exists for lift truck scales and methods of using the same that are more accurate and require less adjustment time.

Moreover, a need exists for lift truck scales that replace flexures with chains and/or cables. More specifically, a need exists for lift truck scales and methods of using the same that allow the load sensor to bear the entirety of the weight of the load for accurate readings.

Further, a need exists for lift truck scales that allow for easy and quick adjustments thereto. Still further, a need exists for lift truck scales that allow for in-motion weighing of a load thereon.

### SUMMARY OF THE INVENTION

The present invention relates to lift truck scales. Specifically, the lift truck scales of the present invention comprise a scale assembly comprising a back plate and a front plate, the back plate connected to a mast on a lift truck and the front plate having a pair of forks for holding pallets or other items thereon. The front plate is held to the back plate via a plurality of laterally spaced and adjustable chains or cables near a top thereof and allowed to move vertically relative to each other via a roller near a bottom thereof. One or more load sensing elements or load cells can be utilized to determine the weight of the load. The present invention minimizes inaccurate load readings, allows for quick and easy “heel to toe” adjustments of the scale, and further allows for in-motion weighing.

To this end, in an embodiment of the present invention, a forklift truck scale is provided. The forklift truck scale apparatus comprising: a front plate configured to mount first and second forks thereon having a top, a bottom, a first side and a second side; a rear plate configured to be mountable to a mast of a forklift truck and having a top, a bottom, a first side and a second side; a first load sensing element disposed between the front plate and the rear plate wherein the front plate and rear plate are disposed vertically and parallel to each other; at least one connection element connecting the front plate to the rear plate proximal to the tops of the front and rear plates, respectively; and a laterally-positioned roller between the front and rear plates proximal the bottoms of the front and rear plates.

In an embodiment, the first load sensing element is proximal the first sides of the front and rear plates, respectively.

In an embodiment, the forklift truck scale apparatus comprising: a second load sensing element disposed between the front plate and the rear plate and proximal the second sides of the front and rear plates, respectively.

In an embodiment, the connection element is selected from the group consisting of a chain and a cable.

In an embodiment, the forklift truck scale apparatus comprises: a plurality of connection elements connecting the front plate to the rear plate proximal to the tops of the front and rear plates, respectively.

In an embodiment, the plurality of connection elements are disposed adjacent each other and are positioned parallel to top edges of the front and rear plates, respectively.

In an embodiment, the at least one connection element comprises an adjustment element configured to adjust the distance between the front and rear plates.

In an alternate embodiment of the present invention, a forklift truck scale system is provided. The forklift truck scale system comprises: a forklift truck comprising a mast and a control for moving the mast up and down; and a forklift truck scale apparatus attached to the mast, the lift truck scale apparatus comprising: a front plate having first and second forks mounted thereon for holding a load thereon, the front plate further having a top, a bottom, a first side and a second side; a rear plate mounted to the mast of a forklift truck and having a top, a bottom, a first side and a second side; a first load sensing element disposed between the front plate and the rear plate wherein the front plate and rear plate are disposed vertically and parallel to each other; at least one connection element connecting the front plate to the rear plate proximal to the tops of the front and rear plates, respectively; and a laterally-positioned roller between the front and rear plates proximal the bottoms of the front and rear plates.

In an embodiment, the forklift truck scale system comprises: a second load sensing element disposed between the front plate and the rear plate and proximal the second sides of the front and rear plates, respectively.

In an embodiment, the connection element is selected from the group consisting of a chain and a cable.

In an embodiment, the forklift truck scale system comprises: a plurality of connection elements connecting the front plate to the rear plate proximal to the tops of the front and rear plates, respectively.

In an embodiment, the plurality of connection elements are disposed adjacent each other and are positioned parallel to top edges of the front and rear plates, respectively.

In an embodiment, the at least one connection element comprises an adjustment element configured to adjust the distance between the front and rear plates.

In an embodiment, the forklift truck scale system further comprises: a load carried on the first and second forks, wherein the weight of the load is sensed by the first load sensing element and transferred to a display.

In yet another alternate embodiment of the present invention, a method of using a forklift truck scale system is provided. The method comprises: providing a forklift truck comprising a mast and a control for moving the mast up and down; providing a forklift truck scale apparatus attached to the mast, the lift truck scale apparatus comprising: a front plate having first and second forks mounted thereon for holding a load thereon, the front plate further having a top, a bottom, a first side and a second side, a rear plate mounted to the mast of a forklift truck and having a top, a bottom, a first side and a second side, a first load sensing element disposed between the front plate and the rear plate wherein the front plate and rear plate are disposed vertically and parallel to each other, at least one connection element connecting the front plate to the rear plate proximal to the tops of the front and rear plates, respectively, and a laterally-positioned roller between the front and rear plates proximal the bottoms of the front and rear plates; placing a load on the first and second forks; sensing the weight of the load via the first load sensor; and displaying the weight of the load on a display.

In an embodiment, the forklift truck scale apparatus further comprises a second load sensing element disposed between the front plate and the rear plate and proximal the second sides of the front and rear plates, respectively, and the method further comprises the step of sensing the weight of the load via the first and the second load sensors.

In an embodiment, the connection element is selected from the group consisting of a chain and a cable.

In an embodiment, the forklift truck scale apparatus further comprises a plurality of connection elements connecting the front plate to the rear plate proximal to the tops of the front and rear plates, respectively.

In an embodiment, the plurality of connection elements are disposed adjacent each other and are positioned parallel to top edges of the front and rear plates, respectively.

In an embodiment, the at least one connection element comprises an adjustment element configured to adjust the distance between the front and rear plates, the method further comprising the step of adjusting the distance between the front and rear plates by adjusting the adjustment element.

It is, therefore, an advantage and objective of the present invention to provide improved lift truck scales and methods of using the same.

Specifically, it is an advantage and objective of the present invention to provide lift truck scales and methods of using the same that are more accurate and require less adjustment time.

Moreover, it is an advantage and objective of the present invention to provide lift truck scales that replace flexures with chains and/or cables.

More specifically, it is an advantage and objective of the present invention to provide lift truck scales and methods of using the same that allow the load sensor to bear the entirety of the weight of the load for accurate readings.

Further, it is an advantage and objective of the present invention to provide lift truck scales that allow for easy and quick adjustments thereto.

Still further, it is an advantage and objective of the present invention to provide lift truck scales that allow for in-motion weighing of a load thereon.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a forklift truck having a lift truck scale in an embodiment of the present invention.

FIG. 2 illustrates a perspective view of a lift truck scale in an embodiment of the present invention.

FIG. 3 illustrates a right side view of a lift truck scale in an embodiment of the present invention.

FIG. 4 illustrates a left side view of a lift truck scale in an embodiment of the present invention.

FIG. 5 illustrates rear view of a front plate of a lift truck scale and a close-up view thereof in an embodiment of the present invention.

FIG. 6 illustrates a view within a cab of a fork lift truck showing a scale display in an embodiment of the present invention.

### DETAILED DESCRIPTION OF THE PRESENTLY PREFERRED EMBODIMENTS

The present invention relates to lift truck scales. Specifically, the lift truck scales of the present invention comprise a scale assembly comprising a back plate and a front plate, the back plate connected to a mast on a lift truck and the front plate having a pair of forks for holding pallets or other items thereon. The front plate is held to the back plate via a plurality of laterally spaced and adjustable chains or cables near a top thereof and allowed to move vertically relative to each other via a roller near a bottom thereof. One or more load sensing elements or load cells can be utilized to determine the weight of the load. The present invention minimizes inaccurate load readings, allows for quick and easy “heel to toe” adjustments of the scale, and further allows for in-motion weighing.

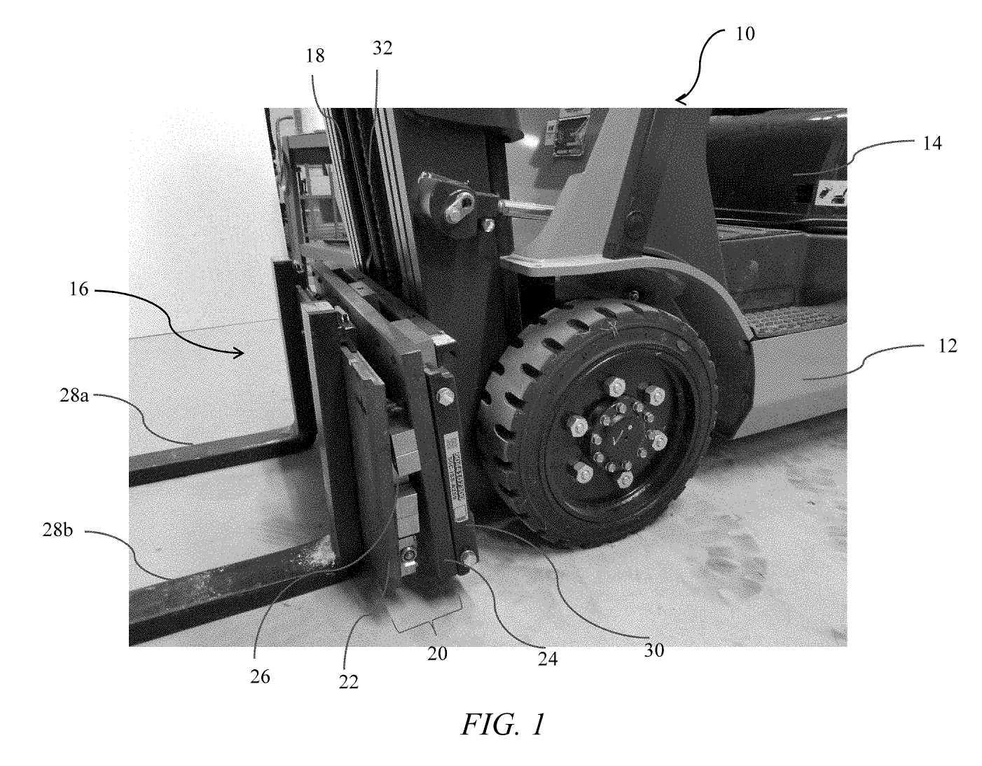

FIG. 1 illustrates a forklift apparatus 10 in an embodiment of the present invention. The forklift apparatus 10 comprises a truck 12 having a cab 14 for a driver of the truck 12 having a set of controls therein for controlling a forklift 16 that is mounted on a mast 18 as is typical for forklifts and used for picking up and hauling objects, such as pallets, boxes, and other like goods.

The forklift 16 may comprise a scale 20 comprising a front plate 22 and a rear plate 24 that are spaced apart and parallel to each other, and having one or more load sensing elements 26a, 26b therebetween, as described in more detail below. The front plate 22 further has a pair of forks 28a, 28b extending therefrom and useful to picking up and hauling objects. The scale 20 is held via a carriage 30 to the mast 18, thereby rigidly holding the same thereto. The driver controls the carriage 30 by controlling a hydraulic lever thereby moving a large hydraulic cylinder up and down and driving the carriage 30 upwards and downwards for positioning the carriage 30, the scale 20 and, therefore, the forks 28a, 28b, under objects to lifting, holding and carrying the same.

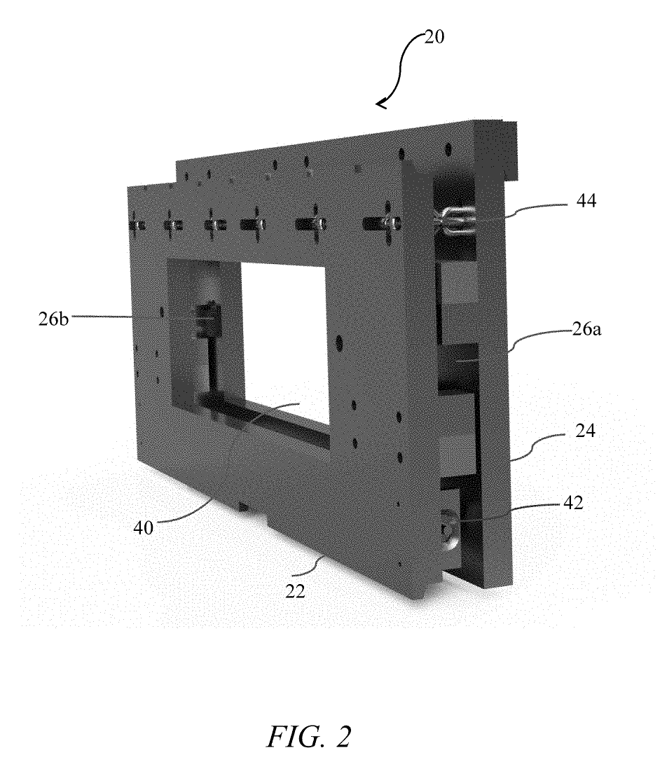

FIG. 2 illustrates a close-up view of the scale 20 in an embodiment of the present invention, including the front plate 22 and the rear plate 24, but without the forks 28a, 28b or the carriage 30 holding the scale 20 to the mast 18. Both the front plate 22 and the rear plate 24 comprise a window 40 therethrough, thereby reducing weight and materials of the scale 20. The scale 20 may generally comprise three main elements: 1) one or more load sensing elements (26a and 26b); 2) a roller bar 42 held between the front plate 22 and the rear plate 24 via brackets 50a, 50b; and 3) a plurality of chains or cables 44 disposed between the front plate 22 and the rear plate 24 for holding the same together.

One or more load sensing elements 26a, 26b may be disposed between the front and rear plates 22, 24, respectively, at about a longitudinal midpoint thereof, and are utilized to transmit all vertical forces through the load sensing elements 26a, 26b and through which the vertical load (i.e., weight of the load) can be accurately measured. As illustrated in FIG. 2, and in a preferred embodiment of the present invention, a first load sensing element 26a and a second load sensing element 26b are positioned on opposite sides of the front and rear plates 22, 24, thereby evenly measuring the weight of a load that is disposed on the forks 28a, 28b. However, it should be noted that any number of load sensing elements may be utilized to measure the load thereon.

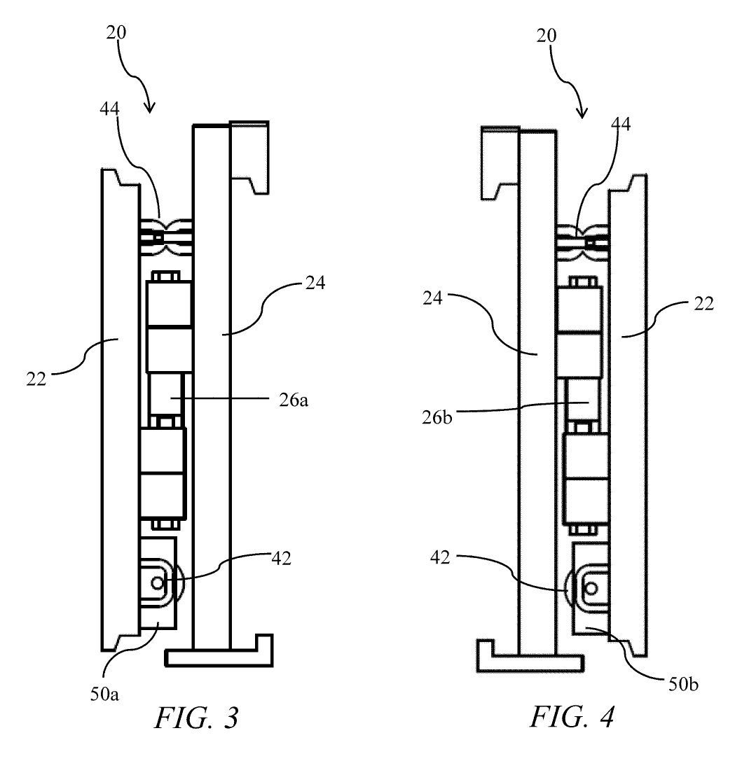

As illustrated in FIG. 3 (showing load sensing element 26a) and in FIG. 4 (showing load sensing element 26b), the load sensing elements 26a, 26b may preferably be electronic strain gauge sensors to measure the weight of the front plate 22, the forks 28a, 28b, and, ultimately, the load carried on the forks 28a, 28b. The weight of the front plate 22, the forks 28a, 28b, and other ancillary parts of the scale 20 may be tared, and so the load sensing elements 26a, 26b may be utilized to measure the weight of the load thereon.

Disposed near a bottom of the front and rear plates 22, 24, and further disposed between the front and rear plates 22, 24, may be a roller 42 held by brackets 50a, 50b and traversing laterally across the front and rear plates 22, 24 from one side thereof to the other. The roller 42 may be held to the front plate 22 via brackets 50a, 50b, but may contact the rear plate 24 and provide a way for the front plate 22 to slide vertically relative to the rear plate 24, thus holding the front plate 22 and the rear plate 24 a specific distance from each other, but movable to allow the full weight of the load on the forks to be transmitted to the load sensing element 26.

Disposed near a top of each of the front plate 22 and the rear plate 24 are the plurality of chains or cables 44 holding the front plate 22 and the rear plate 24 together near the tops thereof. In a preferred embodiment, a plurality of chains or cables 44 are disposed laterally from one side of the front and rear plates 22, 24, respectively, to the other sides thereof, spaced apart from each other to provide strength across the front and rear plates 22, 24.

Generally, the chains or cables 44 hold the front plate 22 and the rear plate 24 a preferred distance from each other when the weight of the load on the forks 28a, 28b pull downwardly. At the same time, the weight of the load presses the roller 42 against the rear plate 24 and act as a pivot point for the front plate 22 relative to the rear plate 24. Generally, the chains or cables 44 do not interfere with the force of the weight pressing down on the load sensing element, but ensure that the front plate 22 does not pull away from the rear plate 24. Thus, the chains or cables allow for complete freedom of downward movement of the front plate 22 relative to the rear plate 24.

Because the chains or cables 44 allow for generally unrestricted vertical movement of the front plate 22 relatively to the rear plate 24, the full weight of the load may be easily and accurately measured. And because there are no flexures in the scale 20 between the front and rear plates 22, 24, respectively, there are no elements that act as springs therein, and so the load constantly applies the downward force onto the sensing element 26 without interfering motions. In-motion weighing of the load on the forks 28a, 28b is therefore possible without undue interference from the various components thereof.

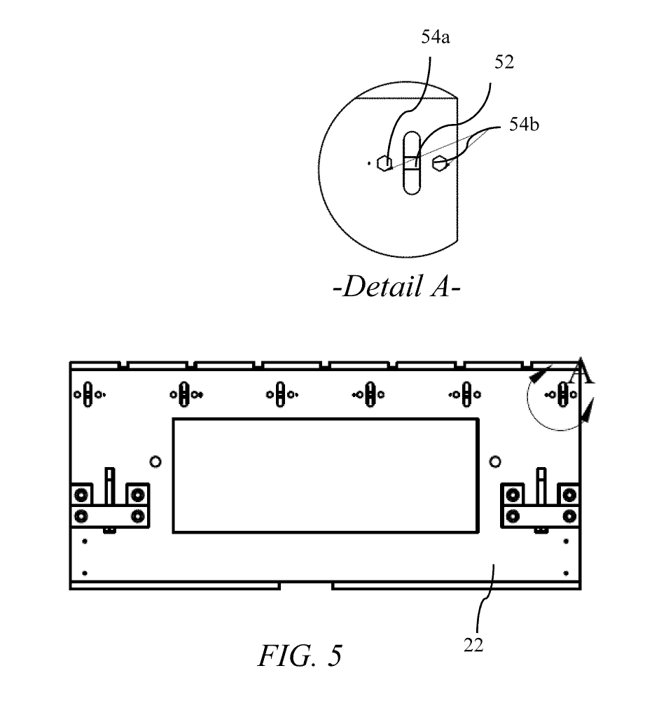

Each chain or cable 44 may be adjusted easily, as illustrated in FIG. 5, showing a rear view of the front plate 22. Specifically, the chains or cables 44 may be held in the front plate 22 and the rear plate 24 via a dowel pin 52 held in place by a pair of set screws 54a, 54b on opposite sides of the chain or cable 44 in apertures. Tightening or loosening the set screws 54a, 54b allows for movement of the dowel pin 52 away from the back plate (via tightening of the set screws 54a, 54b) or toward the back plate (via loosening of the set screws 54a, 54b). Thus, the distance between the front plate 22 and the rear plate 24 may be controlled according to the present invention, thereby adjusting the “heel to toe” variance of the weight. Adjusting the heel to toe variance to zero ensures that the same accurate weight is transmitted to the load sensing element 26 regardless of the positioning of the load on the forks 28a, 28b. Adjustments of the heel to toe variance can be accomplished in minutes to ensure accurate and efficient measuring of the load on the forks 28a, 28b.

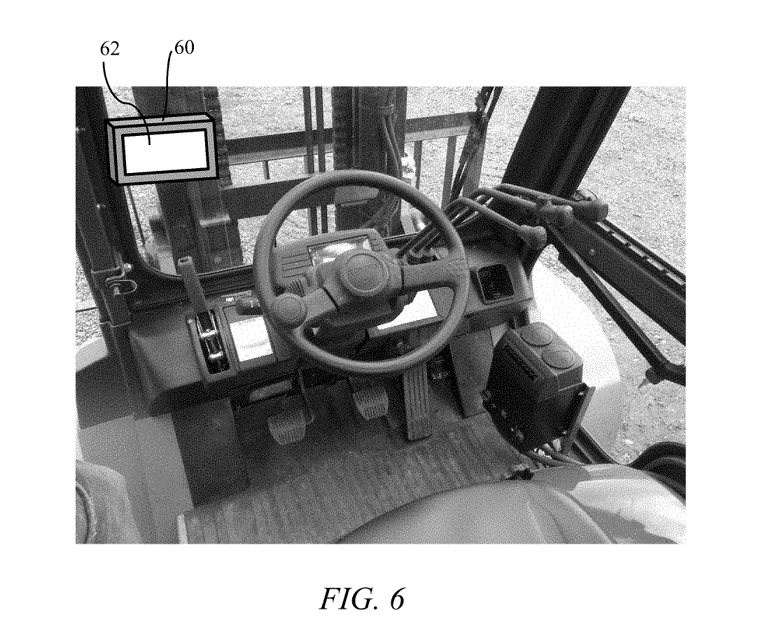

The load sensing elements 26a, 26b, as described hereinabove, may sense the weight of objects on the forks 28a, 28b and may transmit a signal to a processor (not shown) contained within a housing 60 having a display 62 associated therewith. Thus, the measured weight of the object as sensed by the load sensing elements 26a, 26b may be determined by the processor based on the signal received from the load sensing elements 26a, 26b and displayed on the display 62. The display 62 may be contained within the cab of the forklift, as illustrated in FIG. 6, so that the driver thereof may see the weight of the object on the forks 28a, 28b.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

I claim:

1. A forklift truck scale apparatus comprising:
a front plate configured to mount first and second forks thereon having a top, a bottom, a first side and a second side;
a rear plate configured to be mountable to a mast of a forklift truck and having a top, a bottom, a first side and a second side;
a first load sensing element disposed between the front plate and the rear plate wherein the front plate and rear plate are disposed vertically and parallel to each other;
at least one connection element connecting the front plate to the rear plate proximal to the tops of the front and rear plates, respectively; and
a laterally-positioned roller between the front and rear plates proximal the bottoms of the front and rear plates.

2. The forklift truck scale apparatus of claim 1 wherein the first load sensing element is proximal the first sides of the front and rear plates, respectively.

3. The forklift truck scale apparatus of claim 2 comprising:
a second load sensing element disposed between the front plate and the rear plate and proximal the second sides of the front and rear plates, respectively.

4. The forklift truck scale apparatus of claim 1 wherein the connection element is selected from the group consisting of a chain and a cable.

5. The forklift truck scale apparatus of claim 1 comprising:
a plurality of connection elements connecting the front plate to the rear plate proximal to the tops of the front and rear plates, respectively.

6. The forklift truck scale apparatus of claim 5 wherein the plurality of connection elements are disposed adjacent each other and are positioned parallel to top edges of the front and rear plates, respectively.

7. The forklift truck scale apparatus of claim 1 wherein the at least one connection element comprises an adjustment element configured to adjust the distance between the front and rear plates.

8. A forklift truck scale system comprising:
a forklift truck comprising a mast and a control for moving the mast up and down; and
a forklift truck scale apparatus attached to the mast, the lift truck scale apparatus comprising:
a front plate having first and second forks mounted thereon for holding a load thereon, the front plate further having a top, a bottom, a first side and a second side;
a rear plate mounted to the mast of a forklift truck and having a top, a bottom, a first side and a second side;
a first load sensing element disposed between the front plate and the rear plate wherein the front plate and rear plate are disposed vertically and parallel to each other;
at least one connection element connecting the front plate to the rear plate proximal to the tops of the front and rear plates, respectively; and
a laterally-positioned roller between the front and rear plates proximal the bottoms of the front and rear plates.

9. The forklift truck scale system of claim 8 comprising:
a second load sensing element disposed between the front plate and the rear plate and proximal the second sides of the front and rear plates, respectively.

10. The forklift truck scale system of claim 8 wherein the connection element is selected from the group consisting of a chain and a cable.

11. The forklift truck scale system of claim 8 comprising:
a plurality of connection elements connecting the front plate to the rear plate proximal to the tops of the front and rear plates, respectively.

12. The forklift truck scale system of claim 11 wherein the plurality of connection elements are disposed adjacent each other and are positioned parallel to top edges of the front and rear plates, respectively.

13. The forklift truck scale system of claim 8 wherein the at least one connection element comprises an adjustment element configured to adjust the distance between the front and rear plates.

14. The forklift truck scale system of claim 8 further comprising:
a load carried on the first and second forks, wherein the weight of the load is sensed by the first load sensing element and transferred to a display.

15. A method of using a forklift truck scale system comprising:
providing a forklift truck comprising a mast and a control for moving the mast up and down;
providing a forklift truck scale apparatus attached to the mast, the lift truck scale apparatus comprising: a front plate having first and second forks mounted thereon for holding a load thereon, the front plate further having a top, a bottom, a first side and a second side; a rear plate mounted to the mast of a forklift truck and having a top, a bottom, a first side and a second side; a first load sensing element disposed between the front plate and the rear plate wherein the front plate and rear plate are disposed vertically and parallel to each other; at least one connection element connecting the front plate to the rear plate proximal to the tops of the front and rear plates, respectively; and a laterally-positioned roller between the front and rear plates proximal the bottoms of the front and rear plates;
placing a load on the first and second forks;
sensing the weight of the load via the first load sensor; and
displaying the weight of the load on a display.

16. The method of claim 15 wherein the forklift truck scale apparatus further comprises a second load sensing element disposed between the front plate and the rear plate and proximal the second sides of the front and rear plates, respectively, and the method further comprises the step of:
sensing the weight of the load via the first and the second load sensors.

17. The method of claim 15 wherein the connection element is selected from the group consisting of a chain and a cable.

18. The method of claim 15 wherein the forklift truck scale apparatus further comprises a plurality of connection elements connecting the front plate to the rear plate proximal to the tops of the front and rear plates, respectively.

19. The method of claim 18 wherein the plurality of connection elements are disposed adjacent each other and are positioned parallel to top edges of the front and rear plates, respectively.

20. The method of claim 15 wherein the at least one connection element comprises an adjustment element configured to adjust the distance between the front and rear plates, the method further comprising the step of:
adjusting the distance between the front and rear plates by adjusting the adjustment element.
